(19) United States
(12) Patent Application Publication
(10) Pub. No.: US 2016/0214250 A1
(43) Pub. Date: Jul. 28, 2016

(54) SPEED ADJUSTING MECHANISM OF AIR POWERED WRENCH

(71) Applicant: STORM PNEUMTIC TOOL CO., LTD., TAICHUNG CITY (TW)

(72) Inventor: YUNG-YUNG SUN, TAICHUNG CITY (TW)

(21) Appl. No.: 14/602,434

(22) Filed: Jan. 22, 2015

(51) Int. Cl. B25F 5/00; B25B 21/00

(52) U.S. Cl. CPC B25F 5/001; B25B 21/00

(57) ABSTRACT

The present disclosure illustrates a speed adjusting mechanism of an air powered wrench, and a valve rod of the speed adjusting mechanism includes a through hole and a gas outlet hole inside. The gas outlet hole is communicated with a first opening of an axis portion of the speed adjusting member. A fixation member of the speed adjusting mechanism includes a second opening which is intersected and communicated with the first opening. A stop member of the speed adjusting mechanism includes a channel. While the first opening and the second opening are intersected and communicated with each other, after high pressure gas is inputted into the through hole and exhausted through the gas outlet hole, the speed adjusting mechanism limits a flow of the gas to pass the channel and upwardly input into the air intake channel to drive an air motor.

### BACKGROUND OF THE INVENTION

1. Field of the Invention

The present disclosure relates to a speed adjusting mechanism of an air powered wrench, more particularly to a mechanism capable of adjusting a rotating speed of an air motor inside the air powered wrench.

2. Description of the Related Art

Please refer to FIG. 7 which shows a traditional air powered wrench 91. The air powered wrench 91 is provided with a handle 912 at a bottom of the device body 911 thereof, and a driving head 913 at a front end of the device body 911 thereof, and a speed adjusting switch 915 and a positive reverse switch 916 at a trigger 914 which is located at a corner between the device body 911 and the handle 912. The speed adjusting switch 915 is configured for adjusting a rotating speed of an air motor (not shown in FIGs) inside the device body 911. However, when the operator holds the handle 912, the operator is accustomed to put thumb and forefinger at the trigger 914; and when the operator wants to rotate the speed adjusting switch 915, the operator must remove the thumb and the forefinger put at the trigger 914 to allow a finger of other hand to rotate the speed adjusting switch 915 conveniently. In view of the ergonomics, such operation is not convenient for the operator.

Please refer to FIG. 8 which shows other traditional air powered wrench 92. Similar to the air powered wrench 91, the air powered wrench 92 includes a device body 921, a handle 922, a driving head 923, a speed adjusting switch 924 and a positive reverse switch 925, but the difference between the air powered wrench 91 and the air powered wrench 92 is that the speed adjusting switch 924 and the positive reverse switch 925 are disposed at a rear end of the device body 921. However, a length of the device body 921 becomes longer when the speed adjusting switch 924 is disposed at the rear end of the device body 921, and such design cannot meet the demand for slim type.

Please refer to FIG. 9 which shows a handle 93 of another traditional air powered wrench. The handle 93 is provided with a speed adjusting switch 94 disposed at a bottom end thereof, it is obvious that the disposal of the speed adjusting switch 94 is different from the air powered wrenches 91 and 92. As shown in FIG. 9, the speed adjusting switch 94 mainly includes a valve rod 941 and a speed adjusting member 942. The valve rod 941 is positioned in the handle 93 by a bolt 943 being inserted into the valve rod 941. Axially, the valve rod 941 is provided with axial holes 944 which are not communicated with each other (one of the axial holes 944 disposed at bottom end of the valve rod 941 and not shown); radially, the valve rod 941 is provided with two radial holes 945 communicated with the two axial holes 944 respectively. The speed adjusting member 942 is provided with a plurality of speed adjusting holes 946 in multiple apertures, and the flow of the high pressure gas can be adjusted to control a rotating speed of the air motor by respectively aligning different sizes of the speed adjusting holes 946 with the radial hole 945. However, because the structure of the speed adjusting switch 94 must be provided with the axial holes 944, the radial holes 945 and a plurality of speed adjusting holes 946, it causes the problem of complicated structure. In addition, the high pressure gas is exhausted from the lower radial hole 945 and then detoured to enter the upper radial hole 945, and such flow path may cause air flow attenuation and consumption of the driving power for the air motor. The complicated structure also causes problem of difficult repair.

### SUMMARY OF THE INVENTION

In order to solve the above-mentioned problem, a main objective of the present disclosure is to provide a speed adjusting mechanism of an air powered wrench, to achieve effects of ergonomics, convenient adjustment, design without lengthening the device body, simple structure, easy production, less consumption in driving power of the air motor and easy repair.

The air powered wrench is provided with an air intake channel inside a longitudinal handle thereof for inputting high pressure gas, and the speed adjusting mechanism is disposed in the air intake channel at a bottom of the longitudinal handle for adjusting an input flow of the high pressure gas. To achieve the above-mentioned objective, the present disclosure includes a valve rod, a speed adjusting member, fixation member, and a stop member.

The valve rod is provided with a first sleeving portion at a bottom thereof, a positioning portion at a top thereof, a gas outlet hole laterally disposed between the first sleeving portion and the positioning portion, a through hole axially passed through the bottom thereof and communicated with the gas outlet hole, and a second sleeving portion disposed between the positioning portion and the gas outlet hole.

The speed adjusting member is provided with a rotation portion at a bottom thereof, an axis portion coaxially extended from the rotation portion, and an axis hole passed through the rotation portion and the axis portion. The axis portion is in a hollow shape and provided with a first opening at a side thereof, the first opening has only one top edge which is extended to the axis portion. The speed adjusting member is mounted on the first sleeving portion of the valve rod via the axis hole and pivotally rotatable relatively to the valve rod. The gas outlet hole is located at a position with height the same as that of the first opening and communicated with the first opening.

The fixation member is provided with a positioning hole and mounted to the second sleeving portion. The fixation member is fastened and not rotatable relatively to the second sleeving portion and not axially movable. A bottom edge of the fixation member is abutted with atop edge of the axis portion. The fixation member is provided with only one second opening at a side thereof above the first opening, and the second opening is longitudinally passed through the fixation member. The first opening of the axis portion is rotatable with the rotation portion, and the first opening can be directly longitudinally communicated with the second opening without detour while the first opening is intersected with the second opening. A diameter of a communicating space between the first opening and the second first opening is changeable and to be the maximum when the first opening is longitudinally aligned with the second opening.

The stop member is fastened at the positioning portion of the valve rod, and the positioning portion is provided with a channel longitudinal passed therethrough.

While the first opening and the second opening are intersected and communicated with each other, after the high pressure gas is inputted into the through hole and exhausted through the gas outlet hole, the speed adjusting mechanism is configured for limiting the flow of gas passed the channel and upwardly inputted into the air intake channel.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a perspective appearance view of an air powered wrench of the present disclosure.

FIG. 2 is an exploded view of a speed adjusting mechanism at bottom of the longitudinal handle of the present disclosure.

FIG. 3 is a cross-sectional view of the speed adjusting mechanism inside the longitudinal handle of the present disclosure.

FIG. 4 is a schematic view of combination of a speed adjusting member and a muffler cover of the present disclosure.

FIG. 5 is a schematic view of a status of a first opening and a second opening being aligned to maximize opening area, in accordance with the present disclosure.

FIG. 6 is a schematic view of a status of opening area between the first opening and the second opening being the minimum, in accordance with the present disclosure.

FIG. 7 is a perspective appearance view of a traditional air powered wrench.

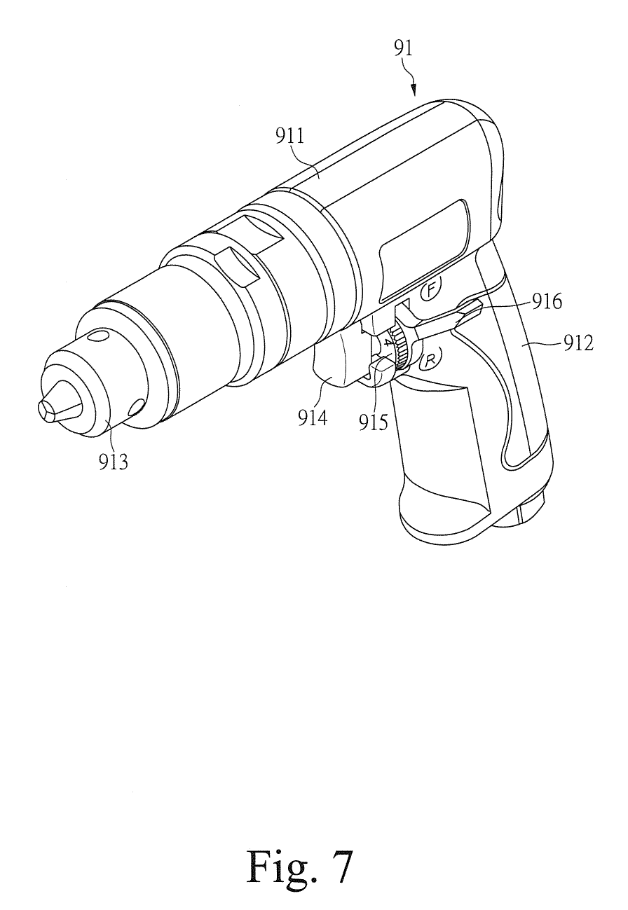

FIG. 8 is a perspective appearance view of other traditional air powered wrench.

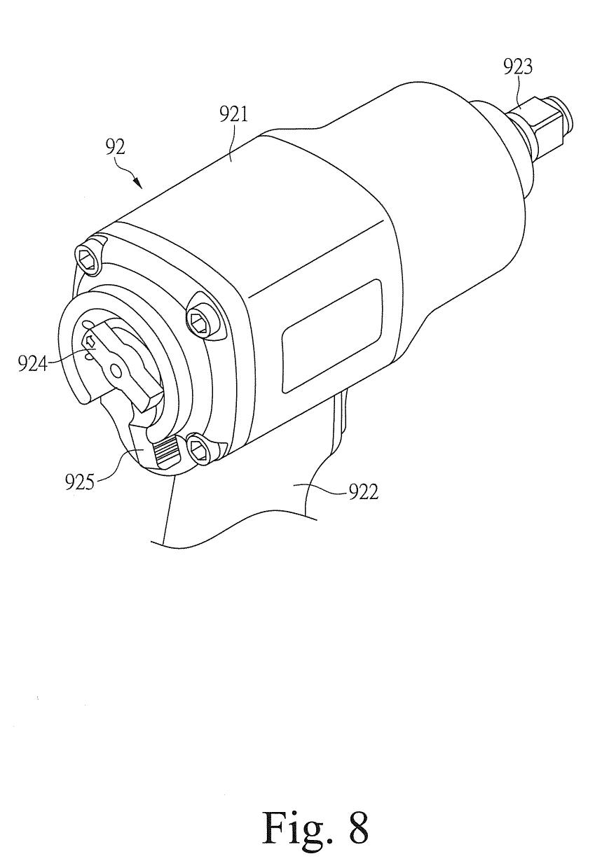

FIG. 9 is an exploded view of the traditional speed adjusting switch at bottom of the handle.

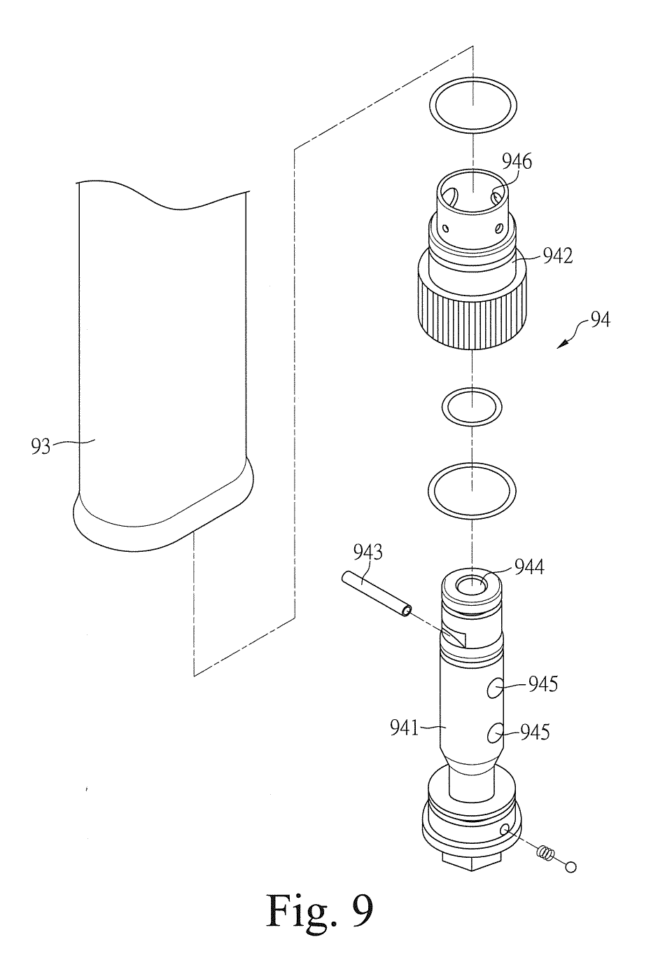

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

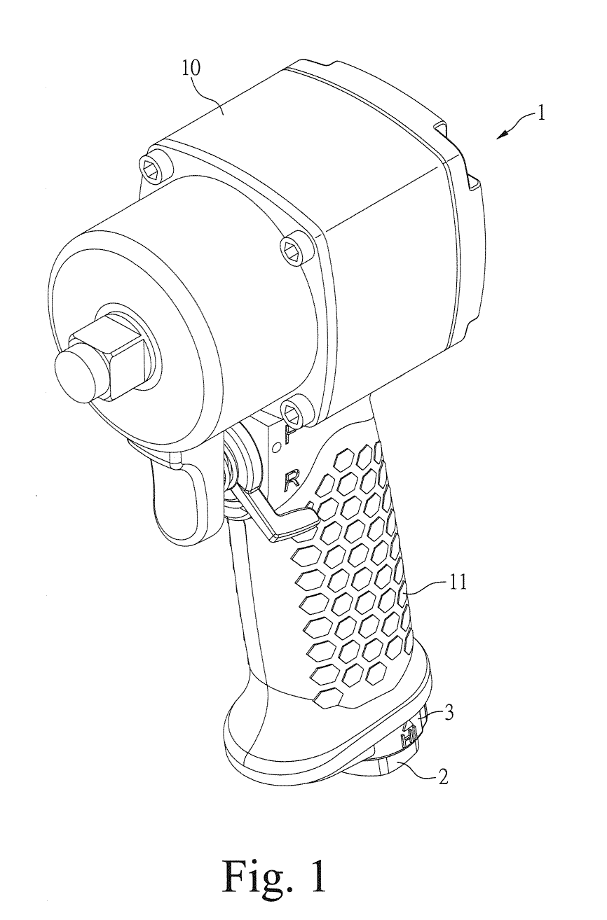

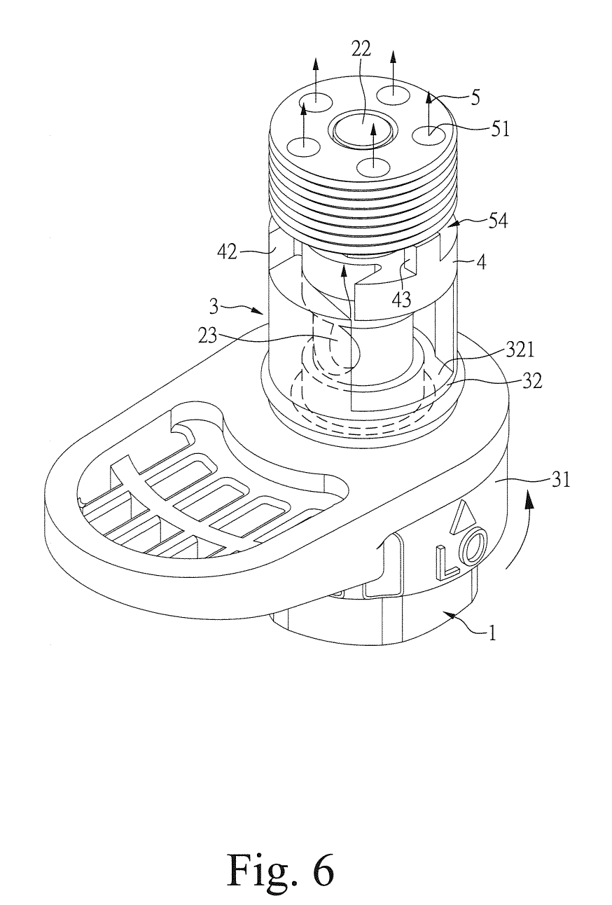

Please refer to FIG. I through FIG. 6 which show the structure of the embodiment of the present disclosure. The structures shown in FIG. 1 through FIG. 6 are taken as examples for illustration; however, the present disclosure is not limited thereto.

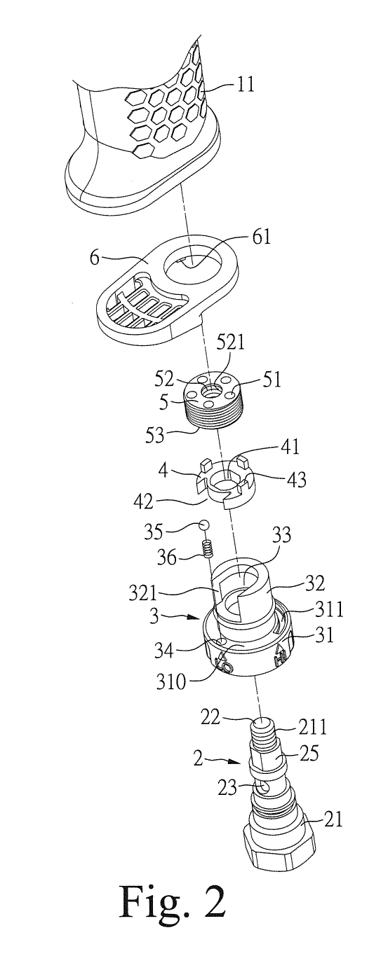

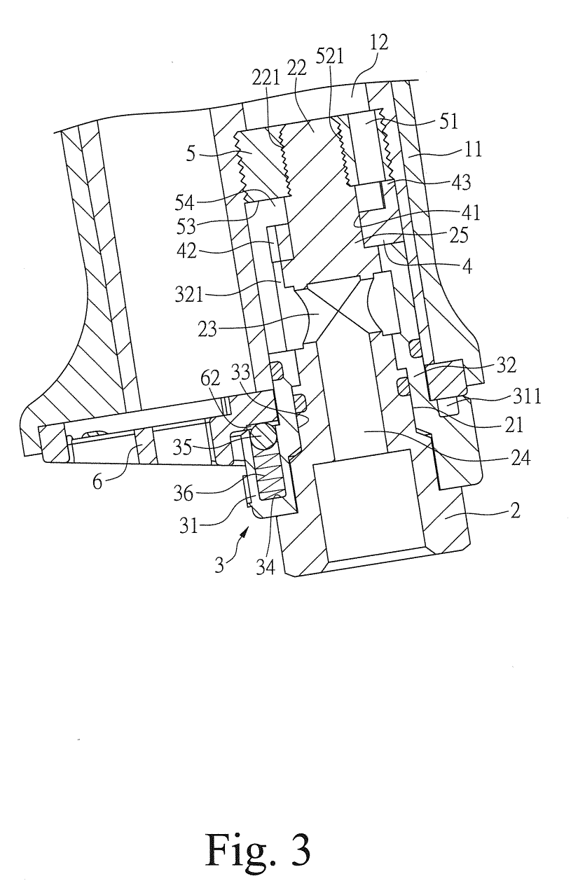

This embodiment provides a speed adjusting mechanism of an air powered wrench, such as an air powered wrench 1 shown in FIG. 1 through FIG. 3. The air powered wrench 1 includes a device body 10 and an air intake channel 12 longitudinally disposed inside a longitudinal handle 11 of the air powered wrench 1. High pressure gas can be inputted into the air intake channel 12 to drive an air motor which is located inside the device body 10 and not shown in FIGs. The speed adjusting mechanism is disposed within the air intake channel 12 at a bottom of the longitudinal handle 11 for adjusting input flow of the high pressure gas. As shown in FIG. 2 and FIG. 3, the speed adjusting mechanism includes a valve rod 2, a speed adjusting member 3, a fixation member 4 and a stop member 5.

As shown in FIG.2 and FIG. 3, the valve rod is provided with a first sleeving portion 21 at a bottom thereof and a positioning portion 22 at a top thereof. A gas outlet hole 23 is disposed between the first sleeving portion 21 and the positioning portion 22, and laterally disposed on the valve rod 2. The valve rod 2 is provided with a through hole 24 inside, and the through hole 24 is axially passed through the bottom of the valve rod 2 and communicated with the gas outlet hole 23. A second sleeving portion 25 is disposed between the positioning portion 22 and the gas outlet hole 23.

As shown in FIG. 2 and FIG. 3, the speed adjusting member 3 includes a rotation portion 31 and an axis portion 32, the rotation portion 31 is disposed at a bottom of the speed adjusting member 3, the axis portion 32 is coaxially extended from the rotation portion 31, and an axis hole 33 is passed through the rotation portion 31 and the axis portion 32. The axis portion 32 is in a hollow shape and provided with only one first opening 321 at a side thereof, and the first opening 321 is extended to a top edge of the axis portion 32. The speed adjusting member 3 is mounted on the first sleeving portion 21 of the valve rod 2 via the axis hole 33 and pivotally rotatable relatively to the first sleeving portion 21. The gas outlet hole 23 is located at a position with a height the same as that of the first opening 321 and communicated with the first opening 321.

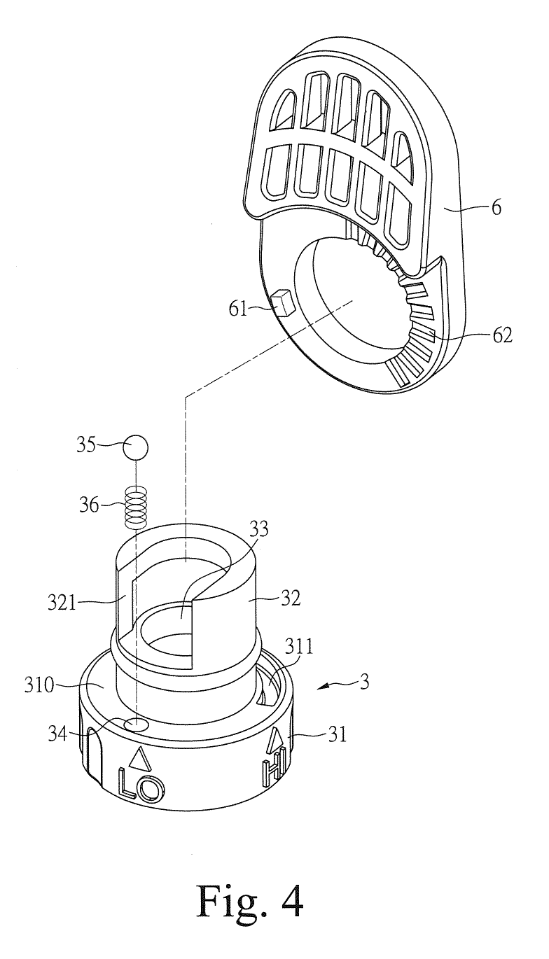

As shown in FIG. 4, in this embodiment a muffler cover 6 is further disposed at the bottom of the longitudinal handle 11, and the rotation portion 31 of the speed adjusting member 3 is abutted with the muffler cover 6 via a step-like edge 310. In this embodiment, the rotation portion 31 is provided with an arc slot 311 disposed on the step-like edge and along a rotating track of the rotation portion 31. The muffler cover is provided 31 with a stop block 61 which is inserted into the arc slot 311 and stopped by two ends of the arc slot 311. A rotation stroke of the rotation portion 31 is limited to a length of the arc slot 311. In this embodiment, the muffler cover 6 is provided with a plurality of positioning slots 62 disposed along the rotating track of the rotation portion 31. The rotation portion 31 is provided with a ball 35 disposed in a hole 34 thereof and pushed by a compression spring 36 in the hole 34. When the ball 35 is placed in one of the plurality of positioning slots corresponding to the rotation of the rotation portion 31, the rotation portion is temporarily positioned after the rotation.

As shown in FIG. 2 and FIG. 3, the fixation member 4 is provided with a positioning hole 41 and mounted to the second sleeving portion 25, and the fixation member 4 is fastened and not rotatable relatively to the second sleeving portion 25 and not axially movable. A bottom edge of the fixation member 4 is abutted against a top edge of the axis portion 32, and the fixation member 4 is provided with only one second opening 321 at a side thereof above the first opening 42. The second opening 42 is longitudinally passed through the fixation member 4. The first opening 321 of the axis portion 32 is rotatable with the rotation portion 31, and the first opening 42 can be directly longitudinally communicated with the second opening without detour while the first opening 321 is intersected with the second opening 42. A diameter of communicating space is changeable and to be the maximum when the first opening is longitudinally aligned with the second opening. In this embodiment, widths of the first opening 321 and the second opening 42 are the same. The positioning hole 41 is a profile hole and in a noncircular shape, and an external profile of the second sleeving portion 25 and the profile-hole shape of the positioning hole 41 are in concave and convex matching.

As shown in FIG. 2 and FIG. 3, the stop member 5 is fastened at the positioning portion 22 of the valve rod 2, and the positioning portion 22 is provided with a channel 51 longitudinal passed therethrough. In this embodiment the stop member 5 is provided with an axis hole 52 which has an inner thread, and the positioning portion 22 of the valve rod 2 is provided with an outer thread 221. The stop member 5 is fastened in the positioning portion 22 by screwing the inner thread 521 of the axis hole 52 with the outer thread 221, and the fixation member 4 is limited to not axially move by the bottom edge 53 of the stop member 5. In this embodiment, the fixation member 4 is provided with a plurality of raising portions 43 protrudingly disposed thereon, and the bottom edge 53 of the stop member 5 is abutted with the plurality of raising portions 43. A space 54 is formed between the fixation member 4 and the stop member 5 to provide the high pressure gas to be flowed between the second opening 42 and the channel 51.

As shown in FIG. 3, the valve rod 2, speed adjusting member 3, the fixation member 4 and the stop member 5 of the speed adjusting mechanism are sealed within the air intake channel 12 at the bottom of the longitudinal handle 11, so the inputted high pressure gas is not leaked from the bottom of the longitudinal handle 11, and the high pressure gas is flowed through the through hole 24, the gas outlet hole 23, the first opening 321, the second opening 42, the space 54 and the channel 51 to upwardly input into the air intake channel 12 to drive the air motor.

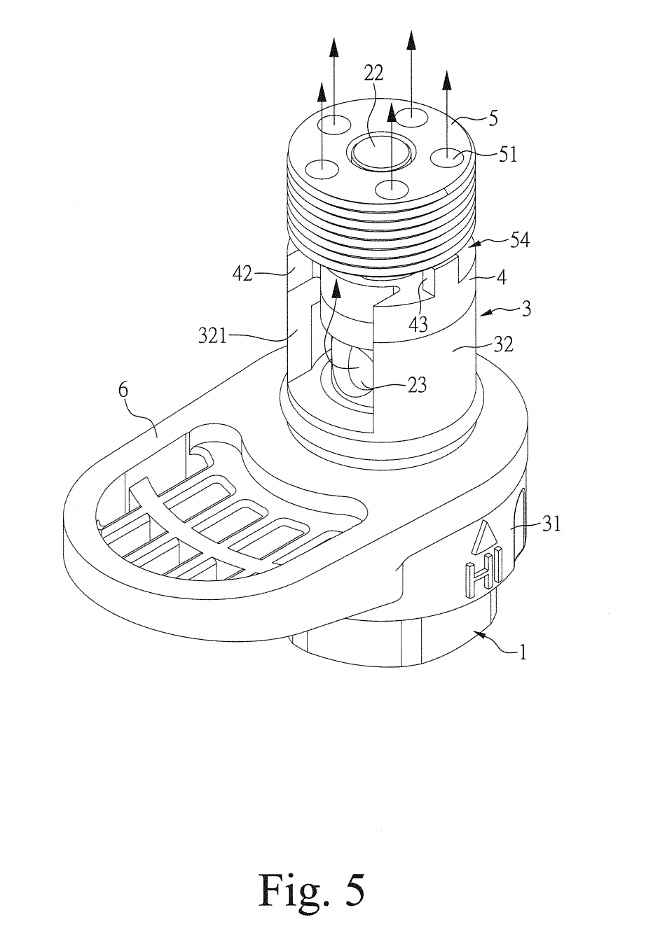

As shown in FIG. 5, after the rotation portion 31 is rotated and first opening 321 of the axis portion 32 is longitudinally aligned with the second opening 42, a diameter of communicating space between the first opening 321 and the second opening 42 is maximum and the flow of the high pressure gas passing through the first opening 321 and the second opening 42, which is inputted from the through hole 24 and exhausted through the gas outlet hole 23, is also the maximum at this time, so the air motor has the highest rotating speed while being driven by such high pressure gas inputted into the air intake channel 12.

As shown in FIG. 6, after the rotation portion 31 is rotated and the first opening 321 of the axis portion 32 is intersected with the second opening 42 but the diameter of the communicating space between the first opening 321 and the second opening 42 is minimum, at this time the high pressure gas inputted via the through hole 24 and exhausted through the gas outlet hole 23 is inputted the space 54 via the first opening 321 and the second opening 42 in minimum flow, so the air motor has the lowest rotating speed while being driven by such high pressure gas inputted into the air intake channel 12.

Please refer to FIG. 5 and FIG. 6. The diameter of the communicating space between the first opening 321 and the second opening 42 is determined by the intersection ratio between the first opening 321 of the axis portion 32 and the second opening 42 which is changed by the rotation of the rotation portion 31. Therefore, after the rotation portion 31 is rotated, the rotation portion 31 can be positioned to a new location by the ball 35 being placing to one of the plurality of positioning slots 62 corresponding to the rotation angle of the rotation portion 31, so as to obtain different degrees of air inflow of the high pressure gas upon the operator's requirement for rotating speed of the air motor.

According to the aforesaid description, it is obvious that the present disclosure has following advantages.

First, compared with the traditional speed adjusting switch 915 of the air powered wrench 91 which is disposed at the trigger 914, the speed adjusting mechanism of the present disclosure is disposed at the bottom of the longitudinal handle 11, so when the user hold the longitudinal handle 11 by a hand and wants to adjust the rotating speed of the air motor, the user can stretch out other hand to reach the bottom of the longitudinal handle 11, without being stopped, to rotate the rotation portion 31 of the speed adjusting member 3, so the speed adjusting function can be achieved. Therefore, the speed adjusting mechanism of the present disclosure has an operation design with ergonomics to achieve a convenient adjusting effect.

Secondly, compared with the traditional speed adjusting switch 924 of the air powered wrench 92 which is disposed at the rear end of the device body 921, the speed adjusting mechanism of the present disclosure is disposed at the bottom of the longitudinal handle 11, so the length of the device body 10 of the present disclosure is not affected by disposal of the speed adjusting mechanism, the problem of the device body being lengthened can be solved, and the air powered wrench of the present disclosure can meet the design demand for slim type.

Thirdly, in the speed adjusting Mechanism of the present disclosure, the first opening 321 is disposed on the axis portion 32 of the speed adjusting member 3, the second opening 42 is disposed on the fixation member 4, so the diameter of communicating space between the first opening 321 and the second opening 42 can be adjusted freely according to the rotation of the rotation portion 31. Compared with the speed adjusting switch 94 of the traditional air powered wrench 93, the speed adjusting mechanism of the present disclosure has a relatively simple structure, so the effect of easy production and repair can be achieved. In addition, the high pressure gas is directly and longitudinally flowed between the first opening 321 and the second opening 42, so the consumption of the driving power can be less than that of the traditional speed adjusting switch 94.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A speed adjusting mechanism of an air powered wrench, the air powered wrench provided with an air intake channel inside a longitudinal handle thereof for inputting high pressure gas, the speed adjusting mechanism disposed in the air intake channel at a bottom of the longitudinal handle for adjusting an input flow of the high pressure gas, the speed adjusting mechanism comprising:
a valve rod, provided with a first sleeving portion at a bottom thereof, a positioning portion at a top thereof, a gas outlet hole laterally disposed between the first sleeving portion and the positioning portion, a through hole axially passed through the bottom thereof and communicated with the gas outlet hole, and a second sleeving portion disposed between the positioning portion and the gas outlet hole;
a speed adjusting member, provided with a rotation portion at a bottom thereof, an axis portion coaxially extended from the rotation portion, and an axis hole passed through the rotation portion and the axis portion, the axis portion in a hollow shape and provided with only one first opening at a side thereof, the first opening extended to an top edge of the axis portion, the speed adjusting member mounted on the first sleeving portion of the valve rod via the axis hole and pivotally rotatable relatively to the valve rod, and the gas outlet hole located at a position with a height the same as that of the first opening and communicated with the first opening;
a fixation member, provided with a positioning hole and mounted to the second sleeving portion, the fixation member fastened and not rotatable relatively to the second sleeving portion and not axially movable, a bottom edge of the fixation member abutted with a top edge of the axis portion, the fixation member provided with only one second opening at a side thereof above the first opening, the second opening longitudinally passed through the fixation member, The first opening of the axis portion rotatable with the rotation portion, wherein the first opening can be directly longitudinally communicated with the second opening without detour while the first opening is intersected with the second opening, a diameter of communicating space is changeable and to be maximum when the first opening is longitudinally aligned with the second opening; and
a stop member, fastened at the positioning portion of the valve rod, and the positioning portion provided with a channel longitudinal passed therethrough;
wherein after the high pressure gas is inputted into the through hole and exhausted through the gas outlet hole, the speed adjusting mechanism is configured for limiting the flow of gas passed the channel and upwardly inputted into the air intake channel while the first opening and the second opening are intersected and communicated with each other.

2. The speed adjusting mechanism of the air powered wrench as defined in claim 1, wherein widths of the first opening and the second opening are the same.

3. The speed adjusting mechanism of the air powered wrench as defined in claim 1, wherein the stop member is provided with an axis hole having an inner thread, the positioning portion of the valve rod is provided with an outer thread, the stop member is fastened in the positioning portion by screwing the inner thread of the axis hole with the outer thread, and the fixation member is limited to not axially move by the bottom edge of the stop member.

4. The speed adjusting mechanism of the air powered wrench as defined in claim 3, wherein the fixation member is provided with a plurality of raising portions protrudingly disposed thereon, the bottom edge of the stop member is abutted against the plurality of raising portions, and a space is formed between the fixation member and the stop member to provide the high pressure gas to flow between the second opening and the channel.

5. The speed adjusting mechanism of the air powered wrench as defined in claim 1, further comprising a muffler cover disposed at the bottom of the longitudinal handle, the rotation portion of the speed adjusting member is abutted with the muffler cover via a step-like edge, and one of the step-like edge of the rotation portion and the muffler cover is provided with an arc slot disposed along a rotating track, and other of the step-like edge of the rotation portion and the muffler cover is provided with a stop block which is inserted into the arc slot and stopped by two ends of the arc slot, a rotation stroke of the rotation portion is limited to a length of the arc slot.

6. The speed adjusting mechanism of the air powered wrench as defined in claim 5, wherein one of the rotation portion and the muffler cover is provided with a plurality of positioning slot, disposed along the rotating track of the rotation portion, and other of the rotation portion and the muffler cover is provided with a ball which is disposed at a hole and pushed by a compression spring, when the ball is placed in one of the plurality of positioning slots corresponding to the rotation of the rotation portion, the rotation portion is temporarily positioned after the rotation.

7. The speed adjusting mechanism of the air powered wrench as defined in claim 1, wherein the positioning hole is a profile hole and in a noncircular shape, and an external profile of the second sleeving portion and the profile-hole shape of the positioning hole are in concave and convex matching.
